(19) United States
(12) Patent Application Publication
(10) Pub. No.: US 2024/0407585 A1
(43) Pub. Date: Dec. 12, 2024

(54) HEATING CONTROL CIRCUIT AND HEATING EQUIPMENT

(71) Applicant: X.J. ELECTRICS (HUBEI) CO., LTD., Huanggang (CN)

(72) Inventor: Yun PAN, Huanggang (CN)

(73) Assignee: X.J. ELECTRICS (HUBEI) CO., LTD., Huanggang (CN)

(21) Appl. No.: 18/343,403

(22) Filed: Jun. 28, 2023

(30) Foreign Application Priority Data
Jun. 6, 2023 (CN) 202321431512.4

(51) Int. Cl. A47J 27/21

(52) U.S. Cl. CPC A47J 27/21091; A47J 27/21166

(57) ABSTRACT

Disclosed are a heating control circuit and a heating equipment. The control module is respectively connected with the zero-crossing detection circuit, the thyristor switch circuit and the temperature control circuit. The time is preset in the control module. If the heating control circuit is powered off, it will be powered on again within the preset time as the signal collected by the zero-crossing detection circuit triggers the conduction of the thyristor switch circuit to start the heating component, and resume the heat preservation mode, by which the body memory function is implemented; even if the heating control circuit is not powered on again within the preset time after the heating control circuit is powered off, the water temperature is detected through the temperature control circuit to realize the water temperature memory function.

### CROSS-REFERENCE TO RELATED APPLICATIONS

This application claims priority to Chinese Patent Application No. 202321431512.4, filed on Jun. 6, 2023, the content of which is incorporated herein by reference in its entirety.

### TECHNICAL FIELD

The present disclosure relates to the field of heating equipment, in particular to a heating control circuit and a heating equipment.

### BACKGROUND

At present, the mechanical electric kettle can not only realize the function of quickly heating water, but also can realize the function of automatic power-off and heat preservation after the water is boiled. However, if the electric kettle leaves the base halfway during the heat preservation process, the heat preservation cannot be continued. If the electric kettle needs to be heated or kept warm again, the heating or keep warm mode needs to be restarted, which is not convenient enough to use.

### SUMMARY

The technical problem to be solved by the present disclosure is to provide a heating control circuit and a heating equipment, so that the heating equipment has a power-off memory function, and can automatically resume the operation mode after the heating equipment is powered on again, so as to improve its convenience.

In order to solve the problems of the technologies described above, the technical solution adopted in the present disclosure is:
a heating control circuit, including a control module, a zero-crossing detection circuit, a thyristor switch circuit, a temperature control circuit and a heating component.

The alternating current is applied to the input end of the zero-crossing detection circuit, the output end of the zero-crossing detection circuit is connected to the first end of the control module; the second end of the control module is respectively connected to the signal input end and signal output end of the thyristor switch circuit, the alternating current is applied to the power supply input end of the thyristor switch circuit, the power supply output end of the thyristor switch circuit is connected to the heating component; the third end of the control module is connected to the temperature control circuit.

In order to solve the above technical problems, another technical solution adopted by the present disclosure is:
a heating equipment, including a kettle body, an electrothermal control board, and a power supply base; the electrothermal control board is arranged at the bottom of the kettle body, and the electrothermal control board is detachably connected to the power supply base; the electrothermal control board includes the above-mentioned heating control circuit.

The beneficial effects of the present disclosure are that the control module is respectively connected with the zero-crossing detection circuit, the thyristor switch circuit and the temperature control circuit, and the time is preset in the control module. If the heating control circuit is powered off, it will be powered on again within the preset time as the signal collected by the zero-crossing detection circuit triggers the conduction of the thyristor switch circuit to start the heating component, and resume the heat preservation mode, by which the body memory function is implemented; even if the heating control circuit is not powered on again within the preset time after the heating control circuit is powered off, the water temperature is detected through the temperature control circuit to realize the water temperature memory function, that is, as long as the water temperature does not reach the specified heat preservation range, the thyristor switch circuit will be automatically turned on, and the heating component will be activated to realize heat preservation.

### BRIEF DESCRIPTION OF THE DRAWINGS

FIG. 1 is a block diagram of a heating control circuit provided by an embodiment of the present disclosure.

FIG. 2 is a pin structure diagram of a control module provided by an embodiment of the present disclosure.

FIG. 3 is a circuit diagram of a thyristor switch circuit provided by an embodiment of the present disclosure.

FIG. 4 is a circuit diagram of a zero-crossing detection circuit provided by an embodiment of the present disclosure.

FIG. 5 is a circuit diagram of a temperature control circuit provided by an embodiment of the present disclosure.

FIG. 6 is a waveform signal diagram provided by an embodiment of the present disclosure.

FIG. 7 is a circuit diagram of a single-color indicator light circuit provided by an embodiment of the present disclosure.

FIG. 8 is a circuit diagram of a two-color indicator light circuit provided by an embodiment of the present disclosure.

FIG. 9 is a pin structure diagram of another control module provided by an embodiment of the present disclosure.

FIG. 10 is a schematic structural diagram of a heating equipment provided by an embodiment of the present disclosure.

### DETAILED DESCRIPTION OF THE EMBODIMENTS

In order to describe the technologies, implemented goals and effects of the present disclosure in detail, the following descriptions will be made in conjunction with the embodiments and accompanying drawings.

Please refer to FIG. 1, an embodiment of the present disclosure provides a heating control circuit, including a control module, a zero-crossing detection circuit, a thyristor switch circuit, a temperature control circuit and a heating component.

The alternating current is applied to the input end of the zero-crossing detection circuit, the output end of the zero-crossing detection circuit is connected to the first end of the control module; the second end of the control module is respectively connected to the signal input end and signal output end of the thyristor switch circuit, the alternating current is applied to the power supply input end of the thyristor switch circuit, the power supply output end of the thyristor switch circuit is connected to the heating component; the third end of the control module is connected the temperature control circuit.

It can be seen from the above description that the beneficial effects of the present disclosure are that the control module is respectively connected with the zero-crossing detection circuit, the thyristor switch circuit and the temperature control circuit, and the time is preset in the control module. If the heating control circuit is powered off, it will be powered on again within the preset time as the signal collected by the zero-crossing detection circuit triggers the conduction of the thyristor switch circuit to start the heating component, and resume the heat preservation mode, by which the body memory function is implemented; even if the heating control circuit is not powered on again within the preset time after the heating control circuit is powered off, the water temperature is detected through the temperature control circuit to realize the water temperature memory function, that is, as long as the water temperature does not reach the specified heat preservation range, the thyristor switch circuit will be automatically turned on, and the heating component will be activated to realize heat preservation.

Further, the thyristor switch circuit includes a thyristor, a switch detection circuit, and a switch control circuit; the second end of the control module includes a signal control end and a signal sampling end.

The signal control end of the control module is connected to the input end of the switch control circuit, and the output end of the switch control circuit is connected to the control electrode of the thyristor; the first main electrode of the thyristor is used to connect said alternating current.

The first main electrode of the thyristor is also connected to the first input end of the switch detection circuit, and the second main electrode of the thyristor is respectively connected to the heating component and the second input end of the switch detection circuit, the signal sampling end of the control module is connected to the output end of the switch detection circuit.

It can be seen from the above description that the thyristor switch circuit controls the conduction degree of the thyristor through the signal input by the zero-crossing detection circuit, thereby controlling the working power of the heating component and preventing the thyristor from being burned in a fully-conducting state.

Further, the switch control circuit includes a first triode, a first resistor, a second resistor, a third resistor and a fourth resistor.

The signal control end of the control module is connected to one end of the first resistor, and the other end of the first resistor is connected to one end of the second resistor and the base of the first triode, and the collector of the first triode is connected to one end of the third resistor; the other end of the second resistor and the emitter of the first triode are grounded; the other end of the third resistor is respectively connected to one end of the fourth resistor and the control electrode of the thyristor, and the other end of the fourth resistor is connected to the first main electrode of the thyristor.

It can be seen from the above description that the control module detects the zero-crossing waveform of the alternating current sine wave through the zero-crossing detection circuit, and then outputs the pulse waveform of the thyristor trigger signal according to the zero-crossing waveform of the alternating current; the pulse waveform of the thyristor trigger signal controls the conduction or disconnection of the thyristor through the switch control circuit to achieve the control of the conduction power of the heating component.

Further, the switch detection circuit includes a fifth resistor, a sixth resistor, a switch component and a second triode.

The first main electrode of the thyristor is connected to one end of the switch component, and the second main electrode of the thyristor is respectively connected to the heating component, the other end of the switch component and one end of the fifth resistor, the other end of the fifth resistor is connected to one end of the sixth resistor, the other end of the sixth resistor is connected to the base of the second triode, and the signal sampling end of the control module is connected to the collector of the second triode; the emitter of the second triode is grounded.

It can be seen from the above description that the switch detection circuit is used to collect the signal value of the switch component on the thyristor, by checking whether the signal sampling end of the control module has collected the corresponding signal, it is possible to determine whether the switch component is closed, thereby determining the operating mode of the heating control circuit.

Further, the zero-crossing detection circuit includes a seventh resistor, an eighth resistor, a first capacitor, a first diode, a second diode, a Zener diode, a polar capacitor, a ninth resistor, a tenth resistor, and third triode.

One end of the seventh resistor is used to connect the live wire of the alternating current, and the other end of the seventh resistor is respectively connected to one end of the eighth resistor, one end of the first capacitor, and one end of the ninth resistor.

The other end of the eighth resistor is respectively connected to the other end of the first capacitor, the anode of the first diode, and the cathode of the second diode.

The cathode of the first diode is respectively connected to the anode of the polar capacitor and the cathode of the Zener diode, and the cathode of the Zener diode is also used to connect the null line of the alternating current.

The anode of the second diode, the cathode of the polar capacitor and the anode of the Zener diode are all grounded.

The other end of the ninth resistor is connected to the base of the third triode, and the collector of the third triode is respectively connected to the first end of the control module and one end of the tenth resistor; the emitter of the third triode is grounded, and the driving voltage is applied to the other end of the tenth resistor.

It can be seen from the above description that the zero-crossing detection circuit is used to detect the zero-crossing point of the AC sine wave, and control the conduction of the thyristor control circuit by determining whether the alternating current reaches the zero-crossing point, so as to suppress the peak pulse in the circuit, thereby realizing the protection of the heating control circuit and prolonging service life.

Further, the temperature control circuit includes a second capacitor, an eleventh resistor and a thermistor.

One end of the second capacitor is respectively connected to the third end of the control module, one end of the eleventh resistor, and one end of the thermistor, the other end of the second capacitor and the other end of the thermistor is grounded, and the driving voltage is applied to the other end of the eleventh resistor.

It can be seen from the above description that the temperature control circuit is used to detect the water temperature. When the temperature control circuit detects that the water temperature has not changed or reaches the temperature threshold, the temperature control circuit can activate the corresponding protection function or early warning function through the control module.

Further, a single-color indicator light circuit is also included, which includes a fourth triode, a twelfth resistor and a single-color light component.

One end of the twelfth resistor is connected to the fourth end of the control module, the other end of the twelfth resistor is connected to the base of the fourth transistor, the collector of the fourth transistor is connected to the single-color light component, and the emitter of the fourth triode is grounded.

It can be seen from the above description that the control module adjusts the brightness of the indicator light through the single-color indicator light circuit to display the working mode of the heating control circuit.

Further, a two-color indicator light circuit is also included, which includes a fifth triode, a sixth triode, a thirteenth resistor, a fourteenth resistor, and a two-color light component.

One end of the thirteenth resistor is connected to the fourth end of the control module, the other end of the thirteenth resistor is connected to the base of the fifth triode, and the collector of the fifth triode is connected to one end of the two-color light component, the other end of the two-color light component is connected to the collector of the sixth triode, the base of the sixth triode is connected to one end of the fourteenth resistor, the other end of the fourteenth resistor is connected to the fifth end of the control module, and the emitter of the fifth triode and the sixth triode are grounded.

It can be known from the above description that the control module displays the working mode of the heating control circuit by switching the color of the indicator light through the two-color indicator light circuit.

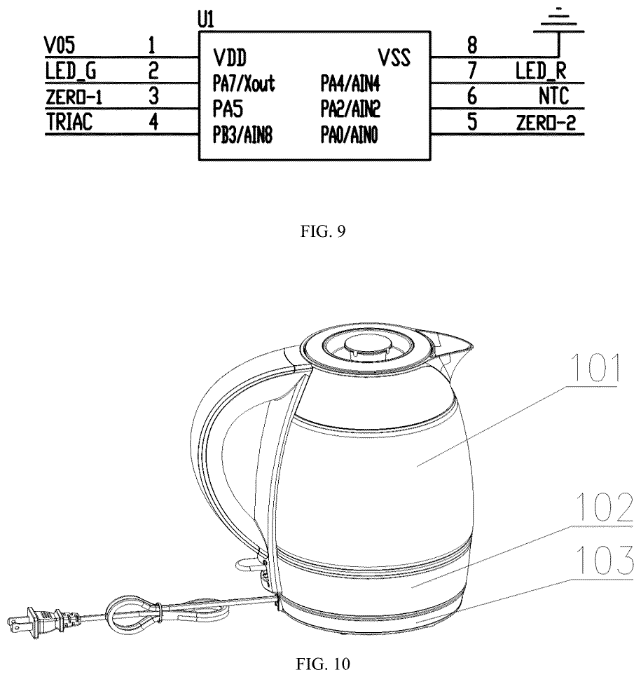

Please refer to FIG. 10, another embodiment of the present disclosure provides a heating equipment, including a kettle body, an electrothermal control board and a power supply base; the electrothermal control board is arranged at the bottom of the kettle body, and the electrothermal control board is detachably connected to the power supply base; the electrothermal control board includes the above-mentioned heating control circuit.

It can be seen from the above description that the beneficial effects of the present disclosure are that the electrothermal control board is arranged at the bottom of the kettle body, and when the electrothermal control board is connected to the power supply base, it operates normally; when the electrothermal control board is separated from the power supply base, the corresponding power-off memory function is implemented by the heating control circuit. The control module is respectively connected with the zero-crossing detection circuit, the thyristor switch circuit and the temperature control circuit, and the time is preset in the control module. If the heating control circuit is powered off, it will be powered on again within the preset time as the signal collected by the zero-crossing detection circuit triggers the conduction of the thyristor switch circuit to start the heating component, and resume the heat preservation mode, by which the body memory function is implemented; even if the heating control circuit is not powered on again within the preset time after the heating control circuit is powered off, the water temperature is detected through the temperature control circuit to realize the water temperature memory function, that is, as long as the water temperature does not reach the specified heat preservation range, the thyristor switch circuit will be automatically turned on, and the heating component will be activated to realize heat preservation.

The heating control circuit and heating equipment provided by the present disclosure enable heating equipment such as electric kettles to have a power-off memory function. When the heating equipment is away from the power supply for a short time or the power is cut off, as long as the heating equipment is powered on again, the previous operation mode prior to the power-off will be automatically restored, which does not need to start the heating equipment again, thus improves its convenience.

Please refer to FIG. 1 to FIG. 6, embodiment one of the present disclosure is: a heating control circuit, including a control module 1, a zero-crossing detection circuit 2, a thyristor switch circuit 3, a temperature control circuit 4, and a heating component LOAD1; specifically, the alternating current is applied to the input end of the zero-crossing detection circuit 2, the output end of the zero detection circuit 2 is connected to the first end of the control module 1; the second end of the control module 1 is respectively connected to the signal input end and the signal output end of the thyristor switch circuit 3, and the alternating current is applied to the power supply input end of the thyristor switch circuit 3, the power supply output end of the thyristor switch circuit 3 is connected to the heating component LOAD1; the third end of the control module is connected to the temperature control circuit 4.

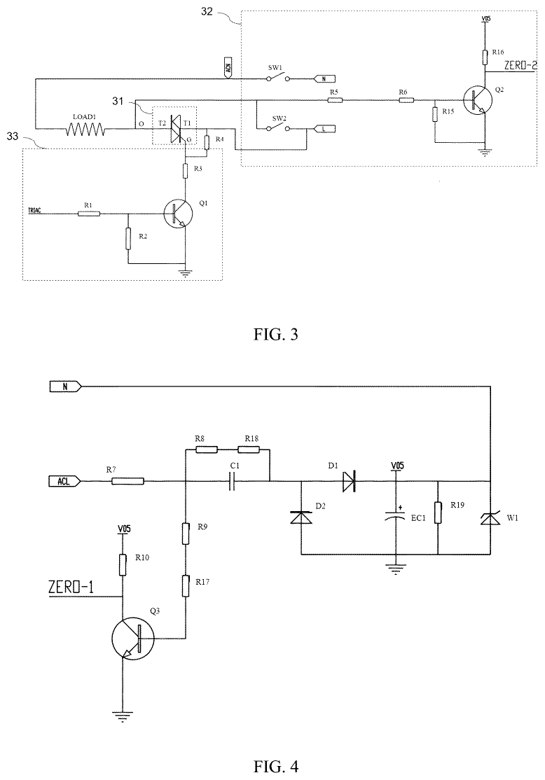

In some embodiments, as shown in FIG. 3, the signal input end of the thyristor switch circuit 3 is TRIAC, the signal output end of the thyristor switch circuit 3 is ZERO-2, and the power supply input end of the thyristor switch circuit 3 is L, and the power supply output end of the thyristor switch circuit 3 is O.

It should be noted that the signal input end TRIAC of the thyristor switch circuit 3 is the input end of the switch control circuit 33 described below, and the signal output end ZERO-2 of the thyristor switch circuit 3 is the output end of the switch detection circuit 32 described below. The power supply input end L of the thyristor switch circuit 3 is the first main electrode T1 of the thyristor 31 described below, and the power supply output end O of the thyristor switch circuit 3 is the second main electrode T2 of the thyristor 31 described below.

The specific circuits of the above-mentioned control module 1, zero-crossing detection circuit 2, thyristor switch circuit 3, temperature control circuit 4 and heating component LOAD1 are as follows.

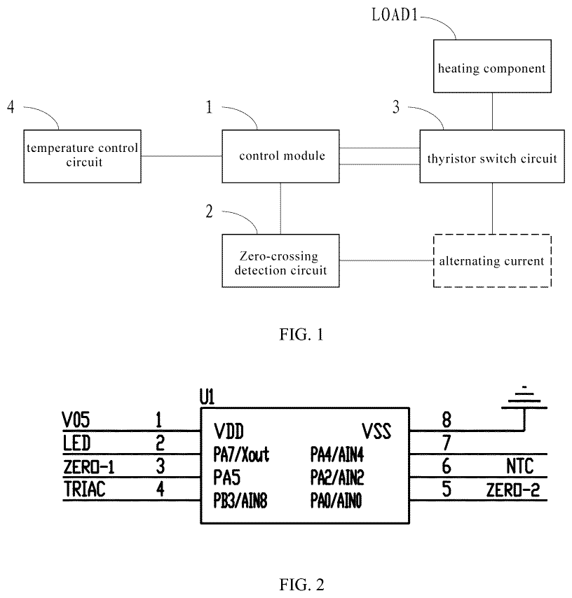

In some embodiments, as shown in FIG. 2, the control module 1 includes 8 ports, the pin-3 PA5 of the control module 1 is the first end, and the pin-4 PB3/AIN8 of the control module 1 is the signal control end in the second end, the pin-5 PA0/AIN0 of the control module 1 is the signal sampling end in the second end, and the pin-6 PA2/AIN2 of the control module 1 is the third end.

Referring to FIG. 3, the thyristor switch circuit 3 includes a thyristor 31, a switch detection circuit 32 and a switch control circuit 33; the second end of the control module 1 includes a signal control end PB3/AIN8 and a signal sampling end PAO/AINO; specifically, the signal control end PB3/AIN8 of the control module 1 is connected to the input end TRIAC of the switch control circuit 32, and the output end of the switch control circuit 33 is connected to the control electrode G of the thyristor 31; the alternating current is applied to the first main electrode T1 of the thyristor 3; the first main electrode T1 of the thyristor 31 is also connected to the first input end of the switch detection circuit 32, and the second main electrode T2 of the thyristor 31 is respectively connected to the heating component LOAD1 and the second input end of the switch detection circuit 32. The signal sampling end PA0/AIN0 of the control module 1 is connected to the output end ZERO-2 of the switch detection circuit 32.

It should be noted that the alternating current includes the null line ACN and the live wire ACL; the first main electrode T1 of the thyristor 31 is used to connect the live wire ACL, and the second main electrode T2 of the thyristor 31 is connected to one end of the heating component LOAD1, the other end of the heating component LOAD1 is used to connect the null line ACN; specifically, the other end of the heating component LOAD1 is connected to one end of the switch component SW1, and the other end of the switch component SW1 is used to connect the null line ACN, so that the switch component SW1 can directly control the activation and disconnection of heating components.

The switch control circuit 33 includes a first triode Q1, a first resistor R1, a second resistor R2, a third resistor R3 and a fourth resistor R4; specifically, the signal control end PB3/AIN8 of the control module 1 is connected to one end of the first resistor R1, the other end of the first resistor R1 is connected to one end of the second resistor R2 and the base of the first triode Q1, and the collector of the first triode Q1 is connected to one end of the third resistor R3; the other end of the second resistor R2 and the emitter of the first triode Q1 are grounded; the other end of the third resistor R3 is respectively connected to one end of the fourth resistor R4 and the control electrode G of the thyristor 31, and the other end of the fourth resistor R4 is connected to the first main electrode T1 of the thyristor 31.

The switch detection circuit 32 includes a fifth resistor R5, a sixth resistor R6, a switch component SW2 and a second triode Q2; specifically, the first main electrode T1 of the thyristor 31 is connected to one end of the switch component SW2, and the second main electrode T2 of the thyristor 31 is respectively connected to the heating component LOAD1, the other end of the switch component SW2 and one end of the fifth resistor R5, the other end of the fifth resistor R5 is connected to one end of the sixth resistor R6, and the signal sampling end PA0/AIN0 of the control module 1 is connected to the other end of the sixth resistor R6 and the base of the second triode Q2, and the signal sampling end PAO/AINO of the control module 1 is connected to the collector of the second transistor Q2; the emitter of the second triode Q2 is grounded.

In some embodiments, the switch detection circuit 32 further includes a fifteenth resistor R15 and a sixteenth resistor R16, the other end of the sixth resistor is also connected to one end of the fifteenth resistor R15, and the other end of the fifteenth resistor R15 is grounded; the collector of the second triode Q2 is also connected to one end of the sixteenth resistor R16, and the driving voltage V05 is applied to the other end of the sixteenth resistor R16.

Referring to FIG. 4, the zero-crossing detection circuit 2 includes a seventh resistor R7, an eighth resistor R8, a first capacitor C1, a first diode D1, a second diode D2, a Zener diode W1, and a polar capacitor EC1, the ninth resistor R9, the tenth resistor R10, and the third triode Q3; specifically, one end of the seventh resistor R7 is used to connect the live wire ACL, and the other end of the seventh resistor R7 is respectively connected to one end of the eighth resistor R8, one end of the first capacitor C1 and one end of the ninth resistor R9; the other end of the eighth resistor R8 is respectively connected to the other end of the first capacitor C1, the anode of the first diode D1 and the cathode of the second diode D2; the cathode of the first diode D1 is respectively connected to the anode of the polar capacitor EC1 and the cathode of the Zener diode W1, and the cathode of the Zener diode W1 is also used to connect the null line ACN; the anode of second diode D2, the cathode of the polar capacitor EC1 and the anode of the Zener diode W1 are grounded; the other end of the ninth resistor R9 is connected to the base of the third triode Q3, and the collector of the third triode Q3 is respectively connected to the first end of the control module 1 and one end of the tenth resistor R10; the emitter of the third triode Q3 is grounded, and the driving voltage V05 is applied to the other end of the tenth resistor R10.

In some embodiments, the zero-crossing detection circuit 2 further includes a seventeenth resistor R17, an eighteenth resistor R18, and a nineteenth resistor R19, as for their specific connection structures, please refer to FIG. 4.

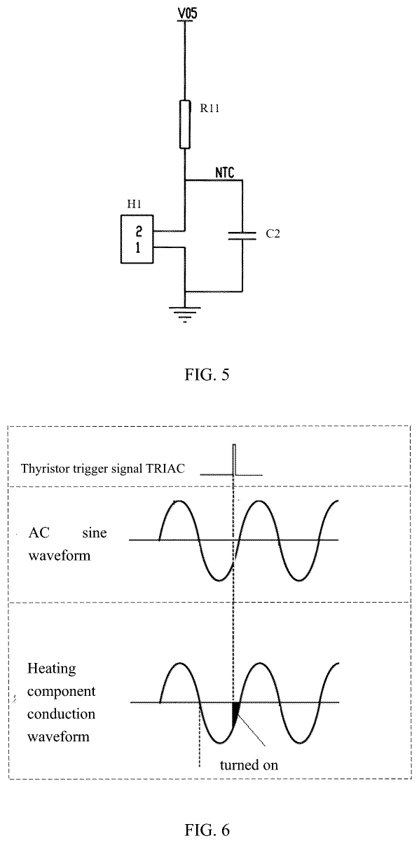

Referring to FIG. 5, the temperature control circuit 5 includes a second capacitor C2, an eleventh resistor R11, and a thermistor H1; specifically, one end of the second capacitor C2 is respectively connected to the third end PA2/AIN2, one end of the eleventh resistor R11 and one end of the thermistor H1, the other end of the second capacitor C2 and the other end of the thermistor H1 are grounded, and the driving voltage V05 is applied to the other end of the eleventh resistor R11.

The working principle of the heating control circuit is specifically: when the heating control circuit is energized to initialize, the LED light is in the off state, the thyristor disenables the heating function, and waits for the switch component SW2 to be closed.

The first end PAS of the control module is connected to ZERO-1 of the zero-crossing detection circuit to sample the zero-crossing signal of the alternating current, so as to control the conduction of the thyristor according to the zero-crossing signal, where the thyristor can be triggered when the zero crossing signal is in the second or fourth quadrant.

The signal sampling end PAO/AINO of the control module is connected to ZERO-2 of the switch detection circuit to sample the signal of the switch component SW2; when the sampling signal of ZERO-2 shows a square wave, the switch component SW2 is in the disconnected state; when there is no square wave in the sampling signal, the switch component SW2 is in the disconnection state. At this time, the control module outputs a high level through the fourth end PA7/Xout to drive the LED indicator light circuit (the single-color indicator light circuit in the embodiment 1 or the two-color indicator light circuit of embodiment 3) to work.

If the thermistor in the temperature control circuit is open or short-circuited, the control module enters the thermistor abnormal alarm mode, that is, the control module drives the LED light to keep flashing until the control module is in normal working state after the fault is removed.

If the temperature control circuit detects that the water temperature is lower than the preset temperature (88° C.), and the switch component SW2 is closed (that is, the water heating function is enabled), the temperature control circuit will continue to detect the water temperature. If the water temperature does not change continuously for 1 minute (the temperature change does not exceed 2° C.)., the control module enters the thermistor abnormal alarm mode. Wherein, when the thermistor is abnormal, it is required to stop starting the heating component for heating. In this way, the protection function of the temperature control circuit is realized.

When the switch component SW2 is closed (that is, the water heating function is enabled), if the temperature control circuit detects that the temperature exceeds the preset temperature (105° C.), the temperature control circuit will drive the LED light through the control module to flash for the preset number of times (20 times) and then go out, and the heating control circuit does not enter the heat preservation mode at the same time. After the thermistor detects that the temperature is lower than a certain temperature (100° C.), the heating control circuit enters the standby state.

The heating control circuit determines whether to enter the heat preservation mode, specifically:
1. When the heating control circuit is heating water, the switch component SW2 is closed, and the temperature control circuit detects that the temperature starts from normal temperature, then when the temperature reaches 90° C., the control module starts the heat preservation mode, and at the same time starts the heat preservation timing function.
2. When the heating control circuit is heating water, the switch component SW2 is disconnected, and the temperature control circuit detects that the temperature has not reached the preset temperature (90° C.), then the control module will not start the heat preservation mode.
3. When the heating control circuit is heating water, the switch component SW2 is not closed, and the temperature control circuit detects that the temperature has reached the preset temperature (90° C.), then the control module will not start the heat preservation mode.
4. When the heating control circuit is heating water, the switch component SW2 is closed, and the temperature control circuit detects that the temperature has reached the preset temperature (90° C.), then the control module starts the heat preservation mode.

The control module starts the heat preservation mode: the first end PA5 of the control module detects the ZERO-1 zero-crossing signal in the AC sine wave through the zero-crossing detection circuit, and generates the thyristor trigger signal TRIAC according to the zero-crossing signal ZERO-1, input it into the second main electrode T2 of the thyristor through the signal control end PB3/AIN8 of the control module to control the conduction degree of the thyristor, thereby controlling the conduction power of the heating component. Refer to the corresponding waveforms shown in FIG. 6.

The control module samples the voltage signal of the circuit in real time. When the voltage sampled by the control module is lower than the preset voltage (4V), the control module enters the power-saving mode; the control module still needs to time the heat preservation time preset by the control module in power saving mode such that the heating control circuit is still working when the heating equipment is in a power-off state; thereby realizing the power-off memory function of the heating control circuit. At the same time, the control module does not control the heat preservation and heating functions of the heating control circuit after entering the power saving mode.

When the heating control circuit is heating for heat preservation, if the user adds cold water, the heat preservation heating time will be delayed at this time to avoid the thyristor device being burned out; if the heating control circuit continues to heat for more than 2 minutes, but the water temperature has not yet reached the heat preservation temperature 88° C., it stops heating for 1 minute and then continues heating, which provides heat dissipation time for the thyristor device. If the heating control circuit is in heat preservation and heating, and the water temperature reaches the heat preservation temperature of 88° C., the thyristor will be disconnected.

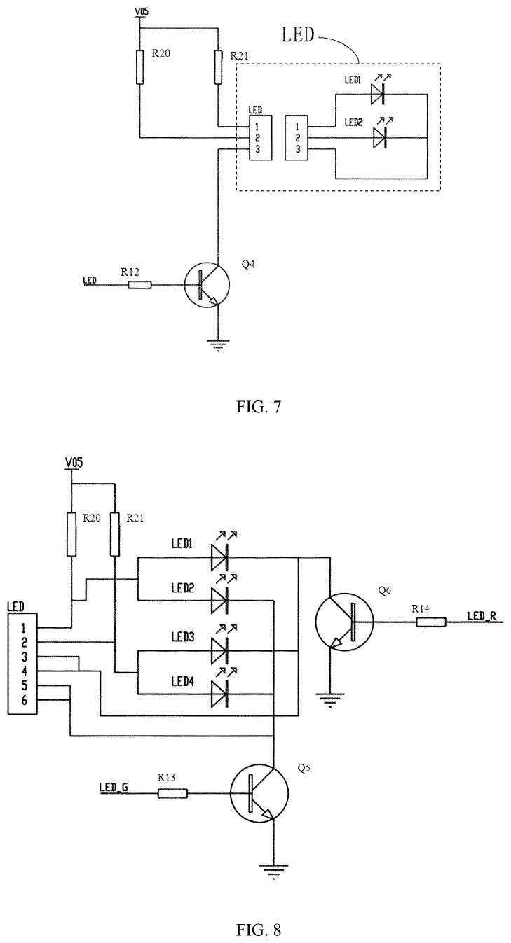

Please refer to FIG. 7, the embodiment 2 of the present disclosure is: a heating control circuit, which is different from embodiment 1 in that: the heating control circuit also includes a single-color indicator light circuit.

Specifically, the single-color indicator light circuit includes a fourth triode Q4, a twelfth resistor R12, and a single-color light component LED; specifically, one end of the twelfth resistor R12 is connected to the fourth end PA7/Xout of the control module 1, the other end of the twelfth resistor R12 is connected to the base of the fourth triode Q4, the collector of the fourth triode Q4 is connected to the single-color light component LED, and the emitter of the fourth triode Q4 is grounded.

In some embodiments, the single-color light component includes a twentieth resistor R20 and a twenty-first resistor R21, as for the specific connection structure thereof, please refer to FIG. 7.

In some embodiments, the pin-2 PA7/Xout of the control module 1 is the fourth end.

The working principle of the heating control circuit is specifically: when the heating control circuit is heating water (SW2 is closed), the control module drives the single-color indicator light circuit to turn on the LED light; when the heating control circuit is in heat preservation and heating (SW2 is disconnected), the control module drives the single-color indicator light circuit to make the LED light dim, that is, the fourth end of the control module outputs ¼ square wave (500 hz) to drive the LED light; when the heating control circuit finishes heat preservation, the control module drives the single-color indicator light circuit to turn off the LED light.

Please refer to FIG. 8 to FIG. 9, embodiment 3 of the present disclosure is: a heating control circuit, which is different from embodiment 1 in that: the heating control circuit also includes a two-color indicator light circuit.

Specifically, the two-color indicator light circuit includes a fifth triode Q5, a sixth triode Q6, a thirteenth resistor R13, a fourteenth resistor R14, and a two-color light component LED; specifically, one end of the thirteenth resistor R13 is connected to the fourth end PA7/Xout of the control module 1, the other end of the thirteenth resistor R13 is connected to the base of the fifth triode Q5, the collector of the fifth triode Q5 is connected to one end of the two-color light component LED, and the other end of the two-color light component LED is connected to the collector of the sixth triode Q6, the base of the sixth triode Q6 is connected to one end of the fourteenth resistor R14, and the other end of the fourteenth resistor R14 is connected to the fifth end PA4/AIN4 of the control module 1, the emitters of the fifth triode Q5 and the sixth triode Q6 are grounded.

In some embodiments, the two-color light component includes a twentieth resistor R20 and a twenty-first resistor R21, as for the specific connection structure, please refers to FIG. 8.

In some embodiments, the pin-2 PA7/Xout of the control module 1 is the fourth end, and the pin-7 PA4/AIN4 of the control module 1 is the fifth end.

The working principle of the heating control circuit is specifically: when the heating control circuit is heating water (SW2 is closed), the control module drives the two-color indicator light circuit to turn on the red LED light; when the heating control circuit is in heat preservation and heating (SW2 is disconnected), the control module drives the two-color indicator light circuit to turn on the green LED light; when the heating control circuit finishes heat preservation and heating, the control module drives the single-color indicator light circuit to turn off the LED light.

Please refer to FIG. 10, the embodiment 4 of the present disclosure is: a heating equipment, including a kettle body 101, an electrothermal control board 102, and a power supply base 103; the electrothermal control board 102 is arranged at the bottom of the kettle body 101, and the electrothermal control board 102 is detachably connected to the power supply base 103; the electrothermal control board 102 includes the heating control circuit described in the embodiment 1.

Its working principle is as follows: when the heating equipment is in the heat preservation state, the heating control circuit starts the heat preservation timing, and at the same time controls the water temperature to always maintain at the preset temperature (88° C.). When the heat preservation time is over, the heat preservation function is immediately disenabled, and the heating equipment enters the standby state and waits for the next water heating.

If in the heat preservation mode, the kettle body is separated from the power supply base, the heating control circuit enters the power saving mode, and the heat preservation and heating cannot be continued at the same time; now the control module in the heating control circuit starts the watchdog timing control mode, and when the kettle body is connected with the power supply base again, the heating control circuit returns to the heat preservation mode. When the heating control circuit returns to the heat preservation mode from the power saving mode, it first determines whether the preset heat preservation time is completed, if so, the heat preservation mode is not resumed, and it enters the standby state; if not, the heat preservation mode is resumed, and the heat preservation is continued.

When the heating equipment is in the water heating state, the kettle body is separated from the power supply base; if the switch component SW2 in the heating control circuit is still closed, the previous working state is retained; if the switch component SW2 in the heating control circuit has been disconnected, the previous operation is ended. In the working state, the heating equipment enters the standby state.

It should be noted that the temperature point parameters involved in the working principle of the above-mentioned embodiment 1 and embodiment 4 include but are not limited to 2° C., 88° C., 90° C., 100° C., and 105° C., which is only an implementation method in a specific application scenario.

In summary, in the heating control circuit and heating equipment provided by the present disclosure, the electrothermal control board is arranged at the bottom of the kettle body, and when the electrothermal control board is connected to the power supply base, it operates normally; when the electrothermal control board is separated from the power supply base, the corresponding power-off memory function is implemented through the heating control circuit. The control module is respectively connected with the zero-crossing detection circuit, the thyristor switch circuit and the temperature control circuit. The time is preset in the control module. If the heating control circuit is powered off, it will be powered on again within the preset time as the signal collected by the zero-crossing detection circuit triggers the conduction of the thyristor switch circuit to start the heating component, and resume the heat preservation mode, by which the body memory function is implemented; even if the heating control circuit is not powered on again within the preset time after the heating control circuit is powered off, the water temperature is detected through the temperature control circuit to realize the water temperature memory function, that is, as long as the water temperature does not reach the specified heat preservation range, the thyristor switch circuit will be automatically turned on, and the heating component will be activated to realize heat preservation. In addition, since the control module outputs a trigger signal to control the thyristor switch circuit to realize the heat preservation and heating function, compared with the method of controlling the thyristor through a switch, the present disclosure can prevent the thyristor from being in a full conduction state, thereby ensuring that the thyristor is not burned.

The above descriptions are only embodiments of the present disclosure, and do not limit the patent scope of the present disclosure. All equivalent transformations made by using the description of the present disclosure and the accompanying drawings, or directly or indirectly used in related technical fields, are all included within the scope of patent protection of the present disclosure.

What is claimed is:

1. A heating control circuit, comprising a control module, a zero-crossing detection circuit, a thyristor switch circuit, a temperature control circuit and a heating component;
wherein alternating current is applied to an input end of the zero-crossing detection circuit, an output end of the zero-crossing detection circuit is connected to a first end of the control module; a second end of the control module is respectively connected to a signal input end and a signal output end of the thyristor switch circuit, the alternating current is applied to a power supply input end of the thyristor switch circuit, a power supply output end of the thyristor switch circuit is connected to the heating component; and a third end of the control module is connected to the temperature control circuit.

2. The heating control circuit according to claim 1, wherein the thyristor switch circuit comprises a thyristor, a switch detection circuit, and a switch control circuit; the second end of the control module comprises a signal control end and a signal sampling end;
the signal control end of the control module is connected to an input end of the switch control circuit, and an output end of the switch control circuit is connected to a control electrode of the thyristor; a first main electrode of the thyristor is used to connect the alternating current; and
the first main electrode of the thyristor is also connected to a first input end of the switch detection circuit, and a second main electrode of the thyristor is respectively connected to the heating component and a second input end of the switch detection circuit; and the signal sampling end of the control module is connected to an output end of the switch detection circuit.

3. The heating control circuit according to claim 2, wherein the switch control circuit comprises a first triode, a first resistor, a second resistor, a third resistor and a fourth resistor;
the signal control end of the control module is connected to one end of the first resistor, and the other end of the first resistor is connected to one end of the second resistor and a base of the first triode, and a collector of the first triode is connected to one end of the third resistor; the other end of the second resistor and an emitter of the first triode are grounded; the other end of the third resistor is respectively connected to one end of the fourth resistor and the control electrode of the thyristor, and the other end of the fourth resistor is connected to the first main electrode of the thyristor.

4. The heating control circuit according to claim 2, wherein the switch detection circuit comprises a fifth resistor, a sixth resistor, a switch component and a second triode;
the first main electrode of the thyristor is connected to one end of the switch component, and the second main electrode of the thyristor is respectively connected to the heating component, the other end of the switch component and one end of the fifth resistor, the other end of the fifth resistor is connected to one end of the sixth resistor, the other end of the sixth resistor is connected to a base of the second triode, and the signal sampling end of the control module is connected to a collector of the second triode; and an emitter of the second triode is grounded.

5. The heating control circuit according to claim 1, wherein the zero-crossing detection circuit comprises a seventh resistor, an eighth resistor, a first capacitor, a first diode, a second diode, a Zener diode, a polar capacitor, a ninth resistor, a tenth resistor and a third triode;
one end of the seventh resistor is used to connect a live wire of the alternating current, and the other end of the seventh resistor is respectively connected to one end of the eighth resistor, one end of the first capacitor, and one end of the ninth resistor;
the other end of the eighth resistor is respectively connected to the other end of the first capacitor, an anode of the first diode, and a cathode of the second diode;
a cathode of the first diode is respectively connected to an anode of the polar capacitor and a cathode of the Zener diode, and the cathode of the Zener diode is also used to connect a null line of the alternating current;
an anode of the second diode, a cathode of the polar capacitor and an anode of the Zener diode are all grounded;
the other end of the ninth resistor is connected to a base of the third triode, and a collector of the third triode is respectively connected to the first end of the control module and one end of the tenth resistor; and an emitter of the third triode is grounded, and driving voltage is applied to the other end of the tenth resistor.

6. The heating control circuit according to claim 1, wherein the temperature control circuit comprises a second capacitor, an eleventh resistor and a thermistor;
one end of the second capacitor is respectively connected to the third end of the control module, one end of the eleventh resistor, and one end of the thermistor, and the other end of the second capacitor and the other end of the thermistor are grounded; and the driving voltage is applied to the other end of the eleventh resistor.

7. The heating control circuit according to claim 1, further comprising a single-color indicator light circuit which comprises a fourth triode, a twelfth resistor and a single-color light component;
wherein one end of the twelfth resistor is connected to a fourth end of the control module, the other end of the twelfth resistor is connected to a base of the fourth triode, a collector of the fourth triode is connected to the single-color light component, and an emitter of the fourth triode is grounded.

8. The heating control circuit according to claim 1, further comprising a two-color indicator light circuit which comprises a fifth triode, a sixth triode, a thirteenth resistor, a fourteenth resistor and two-color light component;
wherein one end of the thirteenth resistor is connected to the fourth end of the control module, the other end of the thirteenth resistor is connected to a base of the fifth triode, and a collector of the fifth triode is connected to one end of the two-color light component, the other end of the two-color light component is connected to a collector of the sixth triode, a base of the sixth triode is connected to one end of the fourteenth resistor, the other end of the fourteenth resistor is connected to the fifth end of the control module, and emitters of the fifth triode and the sixth triode are grounded.

9. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 1.

10. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 2.

11. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 3.

12. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 4.

13. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 5.

14. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 6.

15. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 7.

16. A heating equipment, comprising a kettle body, an electrothermal control board, and a power supply base; wherein the electrothermal control board is arranged at a bottom of the kettle body, and the electrothermal control board is detachably connected to the power supply base; and the electrothermal control board comprises the heating control circuit according to claim 8.
